(19) United States
(12) Patent Application Publication
(10) Pub. No.: US 2018/0236462 A1
(43) Pub. Date: Aug. 23, 2018

(54) GAS-LIQUID SEPARATION DEVICE AND METHOD

(71) Applicant: General Electric Company, Schenectady, NY (US)

(72) Inventors: Junli XUE, Shanghai (CN); Lishun HU, Shanghai (CN); Jie ZHANG, SHanghai (CN); Jing LV, Shanghai (CN); Yong YANG, SHanghai (CN); Liang YU, Shanghai (CN)

(21) Appl. No.: 15/898,447

(22) Filed: Feb. 17, 2018

(30) Foreign Application Priority Data
Feb. 17, 2017 (CN) 201710086184.1

(51) Int. Cl. B04C 3/06; B01D 5/00; B01D 17/02; B04C 5/08

(52) U.S. Cl. CPC B04C 3/06; B04C 5/08; B01D 17/0217; B01D 5/0021

(57) ABSTRACT

The present invention discloses a gas-liquid separation device, including: a vortex generating region, used for receiving a gaseous fluid and providing a gaseous vortex; a fluid conversion region, used for receiving the gaseous vortex and providing a liquid fluid; and a fluid separation region that includes a first fluid passage for receiving the liquid fluid and a second fluid passage for receiving the gaseous fluid which is not converted into liquid fluid, wherein a cross section of the fluid separation region has a first width and a second width, the first width is greater than the second width, and the first fluid passage is connected with the second fluid passage at the position of the first width. The present invention also discloses a gas-liquid separation method.

### TECHNICAL SCOPE

The present invention relates to a gas-liquid separation device and method, and in particular, to a device and method that convert gas into liquid and thus separate the gas from the liquid.

### BACKGROUND

Condensers using supersonic technology have been widely applied in the industry. Specifically, the condenser converts a particular component of a mixed fluid in a gaseous state into liquid, and further separates the particular component in the liquid state from the original mixed fluid in the gaseous state. Such a condenser generally consists of an outer tube with a circular cross section and an inner tube which is located inside of the outer tube and is coaxial with the outer tube. That is, the condenser presents a “tube-in-tube” structure, where there is a gap between the outer tube and the inner tube. The converted liquid fluid will be uniformly distributed on the inner wall of the outer tube under the effect of a centrifugal force, and flow out of the condenser along the inner wall of the outer tube. Meanwhile, most of the unconverted gaseous fluid will be discharged out of the condenser along the inner tube, while a small part of the gaseous fluid will be discharged out of the condenser through the gap between the inner tube and the outer tube. It is understandable that the unconverted gaseous fluid will inevitably mix with the converted liquid fluid and be discharged through the same path, thus affecting the efficiency of gas-liquid separation. In addition, the “tube-in-tube” structure requires relatively high assembly precision and a relatively complex processing technique, both of which increase production and manufacturing costs.

Therefore, there is demand for a new and improved gas-liquid separation device and a corresponding gas-liquid separation method, so as to implement more efficient separation of a gaseous fluid from a liquid fluid, and also to implement easy mounting and maintenance of the separation device, thus effectively reducing production and manufacturing costs.

### BRIEF DESCRIPTION OF THE INVENTION

The first aspect of the present invention provides a gas-liquid separation device including: a vortex generating region, used for receiving a gaseous fluid and providing a gaseous vortex; a fluid conversion region, used for receiving the gaseous vortex and providing a liquid fluid; and a fluid separation region that includes a first fluid passage for receiving the liquid fluid and a second fluid passage for receiving the gaseous fluid which is not converted into the liquid fluid, where a cross section of the fluid separation region has a first width and a second width, the first width is greater than the second width, and the first fluid passage is connected with the second fluid passage at the position of the first width.

The second aspect of the present invention provides a gas-liquid separation method including: receiving a gaseous fluid through a vortex generating region and providing a gaseous vortex; receiving the gaseous vortex through a fluid conversion region and providing a liquid fluid; receiving the liquid fluid through the first fluid passage of a fluid separation region and receiving, through the second fluid passage of the fluid separation region, the gaseous fluid which is not converted into the liquid fluid, where a cross section of the fluid separation region has a first width and a second width, the first width is greater than the second width, and the first fluid passage is connected with the second fluid passage at the position of the first width.

### BRIEF DESCRIPTION OF DRAWINGS

The following detailed description with reference to accompanying drawings can help clarify the features, aspects, and advantages of the present invention, where:

FIG. 1 is a schematic structural diagram of a gas-liquid separation device according to a specific embodiment of the present invention;

FIG. 2 is a schematic structural diagram of a cross section along direction A-A in FIG. 1; and

FIG. 3 is a schematic flowchart of a gas-liquid separation method according to a specific embodiment of the present invention.

### DETAILED DESCRIPTION OF THE INVENTION

The following is a description of one or more preferred embodiments of the present invention. First of all, it is necessary to point out that in order to make the descriptions of specific embodiments concise and specific, it is impossible to detail all features of actual embodiments in these specifications. It should also be noted that in order to achieve the specific objectives of the developer, or to address system-related or business-related limitations, a variety of specific decisions are often made during the actual implementation of any one of these embodiments, which will vary from one implementation to another just as would the processes of any one construction project or design project. In addition, it should also be noted that, although it may take enduring and complex efforts to achieve such a development process, for those possessing common skill or training in the techniques relating to the disclosure of the present invention changes such as design, manufacturing, or production made based on the technical content in the present disclosure are merely common technical approaches, and should not be construed to represent any insufficiency in this disclosure of the present invention.

Unless otherwise defined, the technical and scientific terms in the claims and the specification are used as they normally understood by those skilled in the techniques to which the present invention pertains. “First”, “second”, and similar words used in this specification and in the claims do not denote any order, quantity, or importance, but are merely intended to distinguish between different constituents. The terms “one”, “a”, and the like are not meant to be limiting, but rather denote the presence of at least one. The term “or” includes any one or all of the listed items. The terms “including”, “comprising”, and the like are intended to mean that the presence of an element or thing preceded by the word “including” or “comprising” encompasses elements or objects listed after “including” or “comprising” and their equivalents, and does not exclude other elements or objects.

The present invention relates to a gas-liquid separation device, which includes an improved gas-liquid separation structure, so that the efficiency of gas-liquid separation is effectively improved. Meanwhile, the improved gas-liquid separation structure can also simplify an assembly process, effectively reducing production and manufacturing costs.

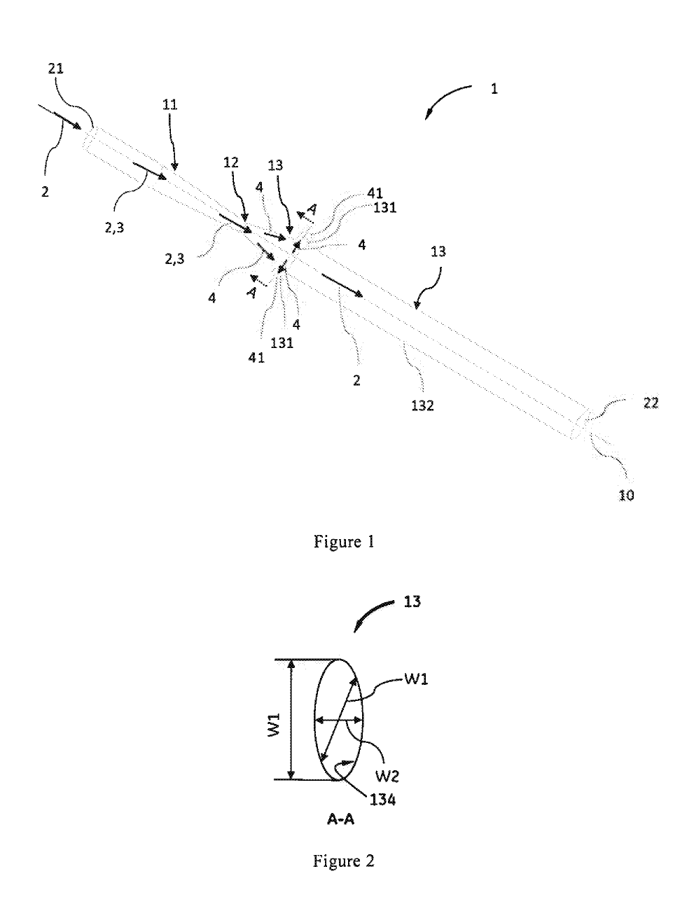

FIG. 1 is a schematic structural diagram of a gas-liquid separation device according to a specific embodiment of the present invention. As shown in FIG. 1, the gas-liquid separation device 1 is shaped as a hollow tube, and can allow a gaseous fluid, a liquid fluid, or a gas-liquid mixed fluid to flow therein. The central axis 10 along gas-liquid separation device 1 includes a vortex generation region 11, a fluid conversion region 12, and a fluid separation region 13 that are connected in sequence.

The vortex generation region 11 can receive a gaseous fluid 2 and provide a gaseous vortex 3. One opening of the vortex generation region 11 includes a gaseous fluid entrance 21 for receiving the gaseous fluid 2. It can be understood that the gaseous fluid 2 may include a single gas component, or may include two or more gas components having different condensation points. In some embodiments, the gaseous fluid 2 comes from a combustion process, a gasification process, or a combination thereof. The gaseous fluid 2 is accelerated in the vortex generation region 11 to reach the velocity of sound, so that a portion of or most of the gaseous fluid 2 is converted to a gaseous vortex 3. The generated gaseous vortex 3 obtains a centrifugal torque under the effect of the velocity of sound. The “velocity of sound” can be understood to represent the velocity of 1 Mach.

In some embodiments, the tube diameter of the vortex generation region 11 continuously reduces from the position of the gaseous fluid entrance 21. Therefore, the kinetic energy of the gaseous vortex 3 that flows at the velocity of sound will change in the vortex generation region 11, and the static temperature of the gaseous vortex 3 will be decreased accordingly.

In some embodiments, the cross section of the vortex generation region 11 may be a plane having a length and a width that are different, such as an ellipse or a polygon. Alternatively, the cross section of the vortex generation region 11 may also be a plane having a length and a width that are the same, such as a circle or a regular polygon. In the drawings of the present invention, the cross section of the vortex generation region 11 is shown as an ellipse.

The fluid conversion region 12 can receive the gaseous vortex 3 and provide a liquid fluid 4. The gaseous vortex 3 generated by the vortex generation region 11 is guided to the fluid conversion region 12 and maintains the velocity of sound in the fluid conversion region 12.

In some embodiments, the fluid conversion region 12 has the minimum tube diameter among all regions of the gas-liquid separation device 1 along the central axis 10. Due to the change in the tube diameter from the vortex generation region 11 to the fluid conversion region 12, the static temperature of the gaseous vortex 3 that keeps flowing at the velocity of sound will be further decreased in the fluid conversion region 12. When the static temperature is decreased to a condensation point of a certain gaseous component, part of the gas will start to become liquid, thus generating a liquid fluid 4.

In some embodiments, the cross section of the fluid conversion region 12 may be a plane having a length and a width that are different, such as an ellipse or a polygon. Alternatively, the cross section of the fluid conversion region 12 may also be a plane having a length and a width that are the same, such as a circle or a regular polygon. In the drawings of the present invention, the cross section of the fluid conversion region 12 is shown as an ellipse.

The fluid separation region 13 can receive the liquid fluid 4 and the gaseous fluid 2 not converted into the liquid fluid 4, and separate the liquid fluid 4 from the gaseous fluid 2.

In some embodiments, the gaseous fluid 2 in the fluid separation region 13 can be accelerated to reach a supersonic speed, so that the kinetic energy of the gaseous fluid 2 changes, thereby decreasing the static temperature thereof. When the static temperature is decreased to a condensation point of a certain gaseous component, the gas starts to become liquid. “Supersonic speed” can be understood to represent a speed greater than 1 Mach.

In the fluid separation region 13, the gas-liquid mixed fluid moving at supersonic speed obtains a centrifugal torque. It can be understood that under the effect of the centrifugal torque, the liquid fluid having a higher density is separated from the gaseous fluid having a lower density, that is, the liquid fluid 4 is separated from the gaseous vortex 3 and the gaseous fluid 2 not converted into the liquid fluid 4. Further, the liquid fluid 4 will flow along the inner wall of the fluid separation region 13 under the centrifugal effect.

In some embodiments, the cross section of the fluid separation region 13 may be a plane having a length and a width that are different, such as an ellipse or a polygon. With reference to FIG. 2, the cross section of the fluid separation region 13 along the central axis 10 is elliptical, and has a first width W1 and a second width W2, the first width W1 being greater than the second width W2. Therefore, the liquid fluid 4 will be gathered at the position of the first width W1 under the centrifugal effect, thus achieving a desirable gas-liquid separation effect.

In some embodiments, the tube diameter of the fluid separation region 13 can increase continuously along the central axis 10 starting from the joint between the fluid separation region 13 and the fluid conversion region 12. A first fluid passage 131 and a second fluid passage 132 are mounted at the position of the first width W1 corresponding to the maximum tube diameter of the fluid separation region 13 so as to receive the liquid fluid 4 and the gaseous fluid 2 not converted into the liquid fluid, respectively. Further, the first fluid passage 131 is formed on an outer side wall of the second fluid passage 132. The central axes of the first fluid passage 131 and the second fluid passage 132 intersect with each other. Specifically, the first fluid passage 131 presents a branch structure, and extends from the front and tail ends of the first width W1 which corresponds to the maximum tube diameter of the fluid separation region 13. The second fluid passage 132 has the same central axis 10 as the fluid conversion region 12, and presents a continuous tubular structure on the same central axis 10. In addition, a liquid fluid exit 41 is formed at one end of the first fluid passage 131 to discharge the liquid fluid 4, and a gaseous fluid exit 22 is formed at one opening of the second fluid passage 132 to discharge the gaseous fluid 2.

In some embodiments, the tube diameter of the fluid separation region 13 may remain basically constant along the central axis 10 (not shown in the figure). The first fluid passage 131 presenting a branch tube structure is mounted at the position of the first width W1 of the cross section of the fluid separation region 13, so as to receive the liquid fluid 4. The second fluid passage 132 presenting a continuous tubular structure is mounted along the central axis 10 of the fluid separation region 13, to receive the gaseous fluid 2 not converted into the liquid fluid 4.

In some embodiments, the shapes of the cross sections of the first fluid passage 131 and the second fluid passage 132 can be circular, elliptical, polygonal, or the like.

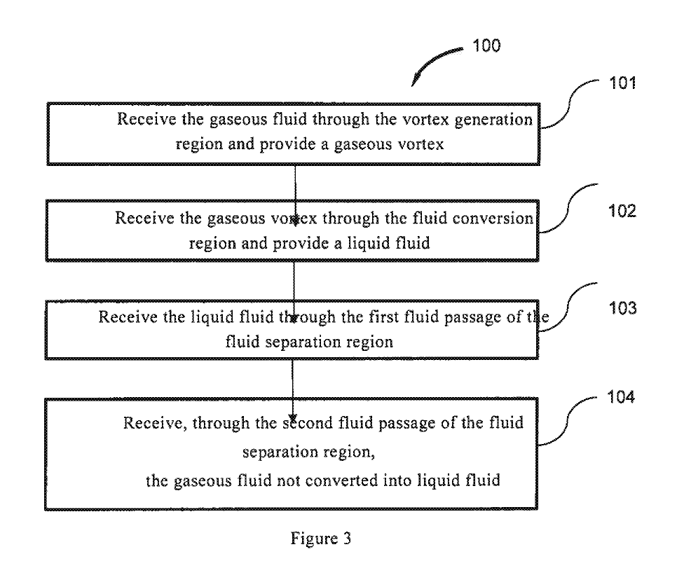

According to the specific embodiments of the present invention, a gas-liquid separation method is further provided. Referring to FIG. 3, the method 100 for implementing gas-liquid separation includes the following steps:

Step 101: receiving a gaseous fluid 2 through vortex generating region 11 and providing a gaseous vortex 3; Step 102: receiving the gaseous vortex 3 through fluid conversion region 12 and providing a liquid fluid 4; Step 103: receiving the liquid fluid 4 through the first fluid passage 131 of fluid separation region 13; and Step 104: receiving, through the second fluid passage 132 of fluid separation region 13, the gaseous fluid 2 which is not converted into liquid fluid, where a cross section of the fluid separation region 13 has a first width W1 and a second width W2, the first width W1 is greater than the second width W2, and the first fluid passage 131 is connected with the second fluid passage 132 at the position of the first width W1.

Further, the fluid conversion region 12 and the fluid separation region 13 have the same central axis 10. The cross section of the fluid separation region 13 along the central axis 10 is an ellipse. At the first width W1 of the ellipse, the first fluid passage 131 is connected with the second fluid passage 132. Moreover, the first fluid passage 131 extends on the outer side wall of the second fluid passage 132 to form a branch structure.

Therefore, the gas-liquid separation device and method provided in the present invention improve the gas-liquid separation structure, so that the liquid fluid is gathered at a particular position more easily and so that the non-condensed gaseous fluid does not leak easily, thus effectively improving the efficiency of separating the liquid fluid from the non-condensed gaseous fluid. Meanwhile, the improved gas-liquid separation structure can also simplify the assembly process, effectively reducing production and manufacturing costs.

Although the present invention is explained based on specific embodiments, it can be understood by those skilled in these techniques as modifiable in various ways. It is therefore to be understood that the appended claims are intended to cover all such modifications and variations insofar as they are within the true spirit and scope of the invention.

What is claimed:

1. An apparatus for gas-liquid separation, comprising:
a cyclonic fluid generation section for receiving a gas fluid and providing a cyclonic fluid;
a fluid conversion section for receiving the cyclonic fluid and providing a liquid fluid; and
a fluid separation section, comprising: a first fluid passage for receiving the liquid fluid; and a second fluid passage for receiving the gas fluid that is not converted to be the liquid fluid;
wherein a cross-section of the fluid separation section has a first width and a second width, the first width is larger than the second width, and the first fluid passage is communicated with the second fluid passage where the first width is.

2. The apparatus of claim 1, wherein the first width is a maximum width of the cross-section of the fluid separation section.

3. The apparatus of claim 1, wherein the first fluid passage extends outwards from the outer surface of the fluid passage.

4. The apparatus of claim 3, wherein the second fluid passage is elliptical in cross-section.

5. The apparatus of claim 1, wherein the fluid conversion section is elliptical in cross-section.

6. The apparatus of claim 1, wherein the cyclonic fluid generation section is elliptical in cross-section.

7. The apparatus of claim 1, wherein the liquid fluid flows into the first fluid passage along an internal surface of the fluid separation section.

8. The apparatus of claim 1, wherein the cyclonic fluid generation section, the fluid conversion section and the fluid separation section have a same central axis.

9. The apparatus of claim 1, further comprising:
a gas fluid inlet formed in an opening of the cyclonic fluid generation section;
a gas fluid outlet formed in an opening of the second fluid passage; and
a liquid fluid outlet formed in an opening of the first fluid passage.

10. A method for gas-liquid separation, comprising:
receiving a gas fluid and providing a cyclonic fluid through a cyclonic fluid generation section;
receiving the cyclonic fluid and providing a liquid fluid through a fluid conversion section;
receiving the liquid fluid through a first fluid passage of a fluid separation section; and
receiving the gas fluid that is not converted to be the liquid fluid through a second fluid passage of the fluid separation section;
wherein a cross-section of the fluid separation section has a first width and a second width, the first width is larger than the second width, and the first fluid separation passage is communicated with the second fluid passage where the first width is.
